(19) United States
(12) Patent Application Publication
(10) Pub. No.: US 2008/0100057 A1
(43) Pub. Date: May 1, 2008

(54) Reminder label

(76) Inventor: Thomas W. MacPhee, Mt. Prospect, IL (US)

Correspondence Address: Thomas W. MacPhee, 106 S. Elm St., Mt. Prospect, IL, 60056, US

(21) Appl. No.: 11/588,922

(22) Filed: Oct. 27, 2006

(51) Int. Cl. B42D 15/00

(52) U.S. Cl. 283/101

(57) ABSTRACT

The present invention provides a label system suitable for use on a package comprising, a foundation label having a first outer boundary defining an area of the foundation label, a first side upon which is imprinted information about a product contained within the package, and a second side coated with an adhesive and contacted to a surface of the package, a non-stick region upon the first side of the foundation label, the non-stick region having a second outer boundary defining an area of the non-stick region, wherein the non-stick region area is smaller than the foundation label area, a reminder label having a first side upon which is imprinted information about the product contained within the package, a second side coated with an adhesive, and an outer boundary less than or equal to the second outer boundary of the non-stick region, and releasably secured to the non-stick region, and wherein the information imprinted upon the first side of the reminder label is from about 0% to about 100% identical to the information imprinted upon the foundation label. The label system can further comprise a shopping list having a first surface and a second surface, and wherein at least on of said surfaces have imprinted thereupon product categories under which are further imprinted areas on which the reminder label can be adhered. A method of reducing consumer confusion by use of said label system is also provided.

### FIELD OF THE INVENTION

The present invention provides generally a packaging label for consumer goods, and more specifically, provides a packaging label system comprising a removable label portion upon which is imprinted information about a particular product. A shopping list to hold at least one removable label portion, and a method of reducing consumer confusion by use of said label system is also provided.

### BACKGROUND OF THE INVENTION

The marketplace has become very competitive, and it has become increasingly difficult for innovative companies to distinguish their goods from those of private label or generic brands thus causing much consumer confusion. While producing high quality product will always be the starting point for gaining an edge over competition and building brand loyalty, labeling plays an equally vital role in commercial success. Consumers are attracted to eye-catching labels and packaging having vibrant colors, imagery, and important product information such as ingredients, nutrition information and the like. An assortment of labels has evolved and will be discussed in more detail below.

U.S. Pat. No. 5,329,713 discloses a combination of a bottle with an outer surface, prescription drugs to be dispensed inside the bottle, and an initial unmodified label. The unmodified label is of negligible thickness and has an overall outline of a first characteristic shape. The unmodified label includes a single contiguous main portion engaging and permanently adhered to the bottle's outer surface and bearing indicia, and having a main outline of a second characteristic shape and providing a main part but less than all of the overall outline. The unmodified label further includes a single contiguous secondary portion confronting but not adhered to the outer bottle surface and bearing indicia and having a secondary outline providing a part but less than all of said overall outline. The main and secondary portions together provide the entirety of the overall outline. An integral destructible connection web between the main portion and the secondary portion joins them. The secondary portion can be separated from the main portion, and removed from the bottle upon destruction of the web, converting the initial unmodified label to a final modified label consisting of the main portion, thus changing the shape of the label from the first characteristic shape to a second characteristic shape, to provide visible indication that the secondary portion has been removed.

U.S. Pat. No. 5,172,936 discloses a label for attaching to a surface and adapted to allow removal of at least one portion of the label from the surface. The label is comprised of at least one permanent portion, and at least one removable portion. Each of the portions has adhering and display sides. The display sides have indicia thereupon. The adhering side of the permanent portion is provided with an adhesive coating providing sufficient adhesion to adhere it to the surface. The adhering side of the removable portion is provided with an adhesive coating providing less adhesion than the adhesion provided by the adhesive coating on the adhering side of the permanent portion so as to allow the removable portion to be adhered to the surface while being capable of being removed from the surface.

U.S. Pat. No. 6,035,568 discloses a label product made up of first and second types of labels formed integrally together. The first type of label includes primary information to be used on a first type of substrate, and the second type of label includes secondary information to be used on a second type of substrate. The label product is comprised of a base layer having upper and lower surfaces, a base adhesive disposed on the lower surface. A permanent portion forms a part of the base layer and has upper and lower surfaces. The lower surface of the permanent portion is coated with a first portion of the base adhesive, the first adhesive portion operative to directly and substantially permanently secure the permanent portion to the first type of substrate. The upper surface of the permanent portion has primary indicia thereon, the primary indicia representing the primary information concerning the first type of substrate. A temporary portion also forms a part of the base layer and is formed by cut lines therein, the temporary portion has upper and lower surfaces. The lower surface of the temporary portion is coated with a second portion of the base adhesive, the upper surface of the temporary portion has secondary indicia thereon, the secondary indicia representing the secondary information regarding the second type of substrate. The temporary portion has means to be selectively releasably adherable to the first type of substrate by the second portion of the base adhesive, removable from the first type of substrate, and readherable to one of the second types of substrates by the second portion of the base adhesive.

U.S. Pat. No. 5,958,536 discloses a two-ply self-adhesive label, comprising an adhesive layer superimposed on a release-liner. The adhesive layer is comprised of an adhesive section and a die-cut detachable section, each of which has an adhesive backing thereon. The release-liner includes a die-cut portion thereof on which the detachable section is superimposed, the die-cut portion being separable from the release liner. The portion of the release liner on which the detachable section is superimposed is configured so that the portion is removable from the release liner. When the adhesive layer is removed from the release-liner and adhered to a first surface, the detachable section of the adhesive layer remains superimposed on the removed portion of the release liner. The detachable section of the adhesive layer is removable from the removed portion of the release-liner at a later time so that it can be adhered to a second surface. The self-adhesive label further comprises a non-adhesive tab connected to the detachable section so as to provide a grip for removing the detachable section from the portion of the release liner after the adhesive layer is adhered to the first surface.

U.S. Pat. No. 6,622,878 discloses a fabricated plastic container molded of a plastic composition and having an exterior surface portion with a continuous solidified layer of gas impermeable material initially liquid coated onto a predetermined zone thereof. A pre-printed peelable label is adhered to the container over and onto the gas impermeable material layer and is generally contiguous with the peripheral boundary thereof. The exterior surface of the portion of the container covered by the layer of gas impermeable material has silk screen imprinted indicia disposed on the surface of the article beneath the layer of gas impermeable material. The gas impermeable material is transparent so that the silk screen indicia is visible therethrough when the label is removed from the container. The pre-printed peelable label is applied over the silk screen article-imprinted indicia such that the indicia pre-printed on the label registers in superimposed relation with, and duplicates, the silk screen article-imprinted indicia beneath it. Application of the label to the container and subsequent removal of the label from the container does not substantially alter the trade dress of the container. The gas impermeable material comprises a silk screening ink.

While all of the above labels perform specific functions, they do not address the problem of consumer confusion due to the abundance of similar products on the market today. A wide variety of products are available for consumers to select from. For example, there are many different varieties of cereals, soaps, shampoos, etc. available from several different manufacturers. Often consumers purchase a specific product suitable for their needs, and dispose of the packaging along with the attached label when the product has been fully consumed. When they return to the store to replenish their stock they may not remember which particular brand and variety of product they had previously purchased.

In other instances, a particular consumer may not be able to shop him or herself, and may ask another person, the designated shopper, to shop for them. While this designated shopper may know generally what type of product is requested, the designated shopper may not know specifically which product is desired. For example, a consumer may desire a specific brand and variety of pasta. The designated buyer, however, may not remember the specific brand of pasta product and purchase a different brand of pasta product that is not desired by the consumer.

Therefore, in order to eliminate the consumer confusion caused by multiple similar products there is a need to accurately and easily record information about the products the consumer desires to repeatedly purchase.

### SUMMARY OF THE INVENTION

The present invention provides a label system suitable for use on a package comprising, a foundation label having a first outer boundary defining an area of the foundation label, a first side upon which is imprinted information about a product contained within the package, and a second side coated with an adhesive and contacted to a surface of the package, a non-stick region upon the first side of the foundation label, the non-stick region having a second outer boundary defining an area of the non-stick region, wherein the non-stick region area is smaller than the foundation label area, a reminder label having a first side upon which is imprinted information about the product contained within the package, a second side coated with an adhesive, and an outer boundary less than or equal to the second outer boundary of the non-stick region, and releasably secured to the non-stick region, and wherein the information imprinted upon the first side of the reminder label is from about 0% to about 100% identical to the information imprinted upon the foundation label. The label system can further comprise a shopping list having a first surface and a second surface, and wherein at least on of said surfaces have imprinted thereupon product categories under which are further imprinted areas on which the reminder label can be adhered.

The present invention further provides a method of reducing consumer confusion when shopping comprising the steps of, purchasing a product having thereon a label system comprising a foundation label having a first outer boundary defining an area of the foundation label, a first side upon which is imprinted information about a product contained within the package, and a second side coated with an adhesive and contacted to a surface of the package, a non-stick region upon the first side of the foundation label, the non-stick region having a second outer boundary defining an area of the non-stick region, wherein the non-stick region area is smaller than the foundation label area, a reminder label having a first side upon which is imprinted information about the product contained within the package, a second side coated with an adhesive, and an outer boundary less than or equal to the second outer boundary of the non-stick region, and releasably secured to the non-stick region, and wherein the information imprinted upon the first side of the reminder label is from about 0% to about 100% identical to the information imprinted upon the foundation label, removing the reminder label, and affixing the reminder label to a shopping list, wherein the shopping list is comprised of a first surface and a second surface, and wherein at least one of said surfaces has imprinted thereupon product categories under which are further imprinted areas on which one or more reminder labels can be affixed.

### BRIEF DESCRIPTION OF THE DRAWINGS

In the drawings,

FIG. 1 is a perspective view of the label system of the present invention;

FIG. 2 is a side elevational view of the label system of the present invention wherein the product replacement reminder label is equal to the size of the non-stick region;

FIG. 3 is a side elevational view of the label system of the present invention wherein the reminder label is smaller than the size of the non-stick region;

FIG. 4 is a perspective view of the label system of the present invention wherein the reminder label is larger than the size of the non-stick region;

FIG. 5 is a side elevational view of the label system of the present invention wherein the reminder label is larger than the size of the non-stick region;

FIG. 6a is a top plan view of the reminder label;

FIG. 6b is a top plan view of the reminder label further comprising a tab;

FIG. 7 is a top plan view of the reminder label further comprising a tab and having a bar code imprinted thereon;

FIG. 8-9 shows a variety of products that the label system of the present invention is suitable for use with including, but not limited to, milk and mouthwash; and

FIG. 10 is a top plan view of a shopping list with a variety of categories created by a consumer and areas to affix one or more reminder labels of the present invention.

### DETAILED DESCRIPTION OF THE INVENTION

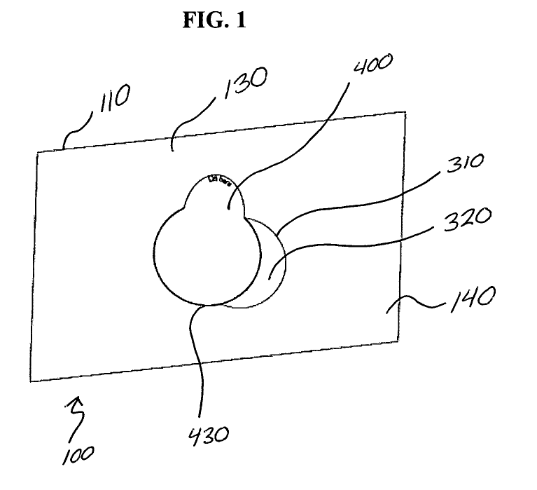

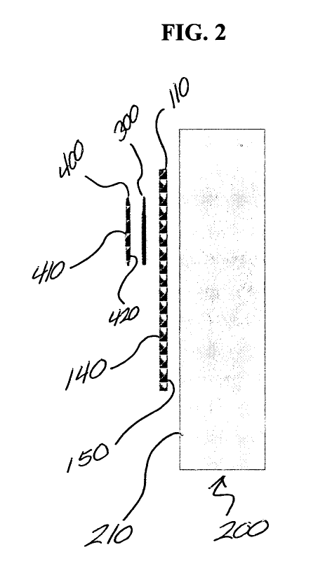

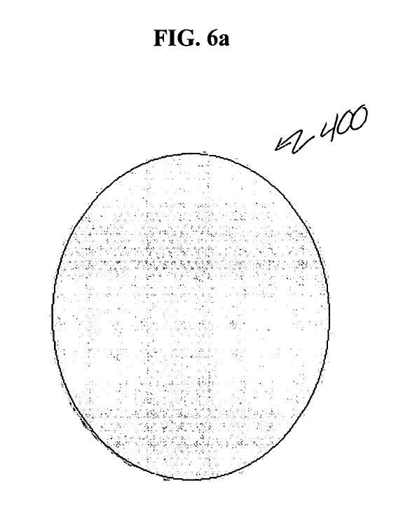

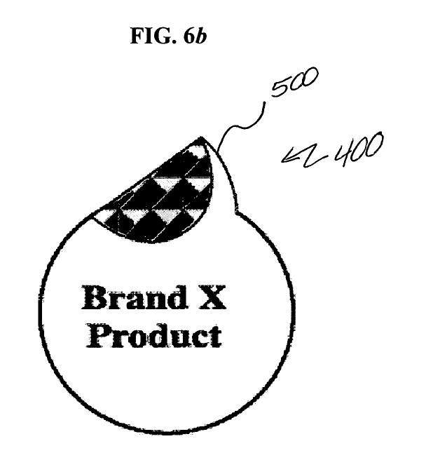

Turning now to the drawings, and particularly FIGS. 1 and 2, what is shown is a label system 100 suitable for use on a package 200. The label system 100 is comprised of a foundation label 110 having a first outer boundary 120 defining an area 130 of the foundation label 110. Foundation label 110 can be constructed from a variety of materials including for example, but not limited thereto, paper, plastic, cardboard and the like. In one embodiment, foundation label 110 is integrally formed with the packaging such as when producing a cereal box, wherein the foundation label is directly printed on the cardboard material. The first side 140 of foundation label 110 can have imprinted thereon information about a product contained within the package 200. The second side 150 of foundation label 110 is coated with an adhesive and can be contacted directly to a surface 210 of the package 200. A non-stick region 300 is provided upon the first side 140 of the foundation label 110. The non-stick region 300 has a second outer boundary 310 defining an area 320 of the non-stick region 300. The non-stick region area 320 is smaller than the foundation label area 130. A reminder label 400 shown in FIG. 6a has a first side 410 upon which is imprinted information about the product contained within the package 200, and a second side 420 coated with an adhesive. Reminder label 400 can be constructed from a variety of materials including for example, but not limited thereto, paper, plastic, cardboard and the like. Outer boundary 430 defines the perimeter of reminder label 400. In one embodiment, the reminder label 400 further comprises a tab 500 as shown in FIG. 6b.

In one embodiment, non-stick region 300 is integrally formed with foundation label 110. In another embodiment, non-stick region 300 is applied to foundation label 110 and is comprised of wax which coats or laminates a predefined region of the foundation label 110. In yet another embodiment, non-stick region 300 is applied to foundation label 110 and is comprised silicon which coats or laminates a predefined region of the foundation label 110.

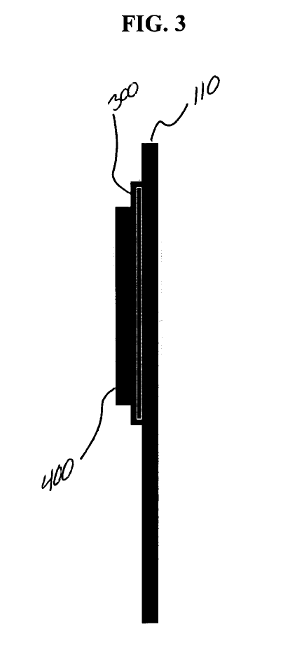

In one embodiment, the outer boundary 430 is equal to the second outer boundary 310 of the non-stick region 300 as shown in FIG. 2. In another embodiment, outer boundary 430 is less the second outer boundary 310 of non-stick region 300as shown in FIG. 3.

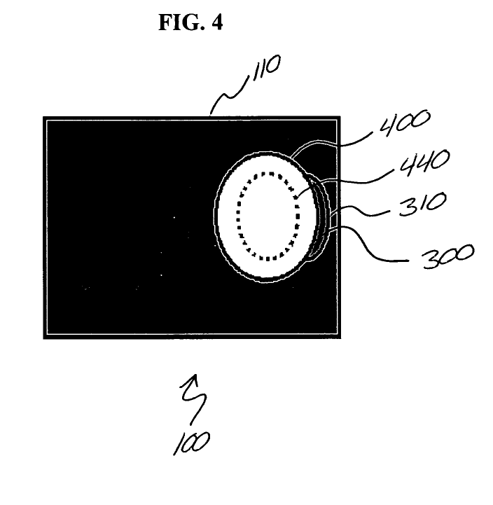

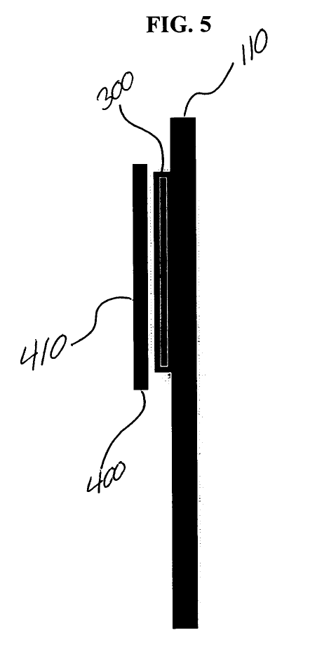

In yet another embodiment, the outer boundary 430 is greater than the second outer boundary 310 of the non-stick region 300, and reminder label 400 has perforations 440 as shown in FIGS. 4 and 5. In one embodiment, perforations 440 directly overlap the second outer boundary 310 of the non-stick region 300. In another embodiment, perforations 440 do not directly overlap the second outer boundary 310 of the non-stick region 300.

Reminder label 400 is releasably secured to the non-stick region 300. In one embodiment, the product information imprinted upon the first side 410 of reminder label 400 is from about 0% to about 100% identical to the information imprinted upon the foundation label. In another embodiment, the product information imprinted upon the first side 410 of reminder label 400 is from about 10% to about 90% identical to the information imprinted upon the foundation label. In yet another embodiment, the product information imprinted upon the first side 410 of reminder label 400 is from about 20% to about 80% identical to the information imprinted upon the foundation label. In another embodiment, the product information imprinted upon the first side 410 of reminder label 400 is from about 30% to about 70% identical to the information imprinted upon the foundation label. In yet another embodiment, the product information imprinted upon the first side 410 of reminder label 400 is from about 40% to about 60% identical to the information imprinted upon the foundation label. In still another embodiment, the product information imprinted upon the first side 410 of reminder label 400 is about 50% identical to the information imprinted upon the foundation label.

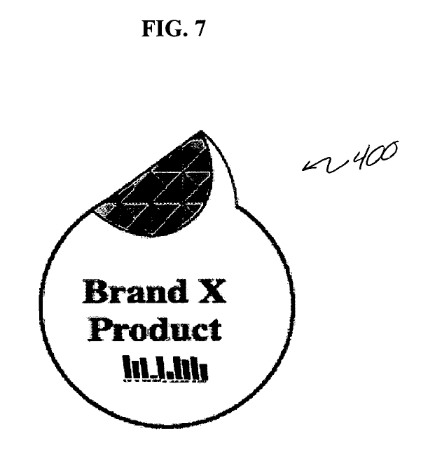

The product information may comprise brand name, product information and/or bar codes as shown in FIG. 7.

Upon creating a label 110, wax or silicon can be applied to a selected area forming the non-stick region 300. Thereafter, the reminder label 400 is coated with an adhesive on its second side 420, and then contacted to non-stick region 300. Packages such as cardboard boxes having print directly thereupon can also be fitted with the label system of the present invention. Upon creating the printed cardboard, and either before formation into the finished box form or afterwards, the wax or silicon can be applied directly upon the package surface in a selected area to form the non-stick region 300 upon which would be applied reminder label 400.

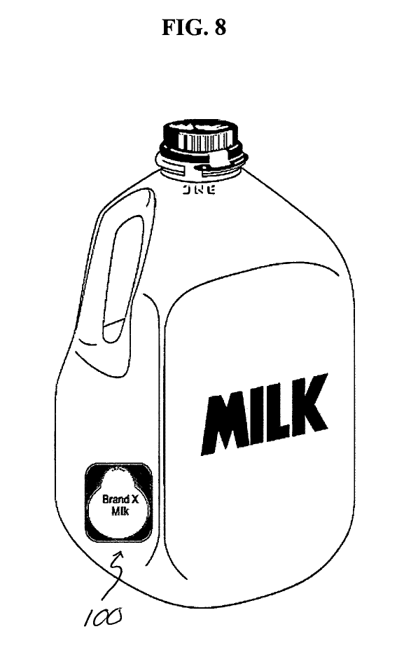

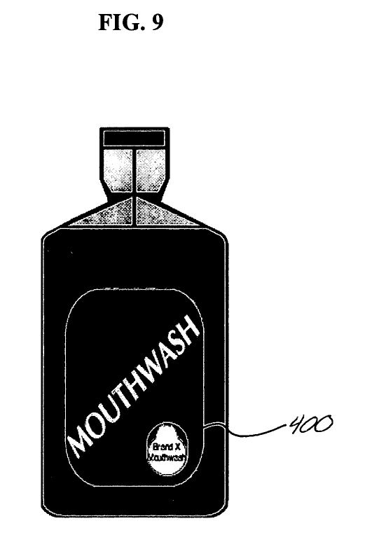

Examples of products and packages that can benefit from label system 100 of the present invention are shown in FIGS. 8-9. It should be made clear that the products shown in FIGS. 8-9 are exemplary and not to be construed as limiting in any way as to which products the present label system 100 can be applied.

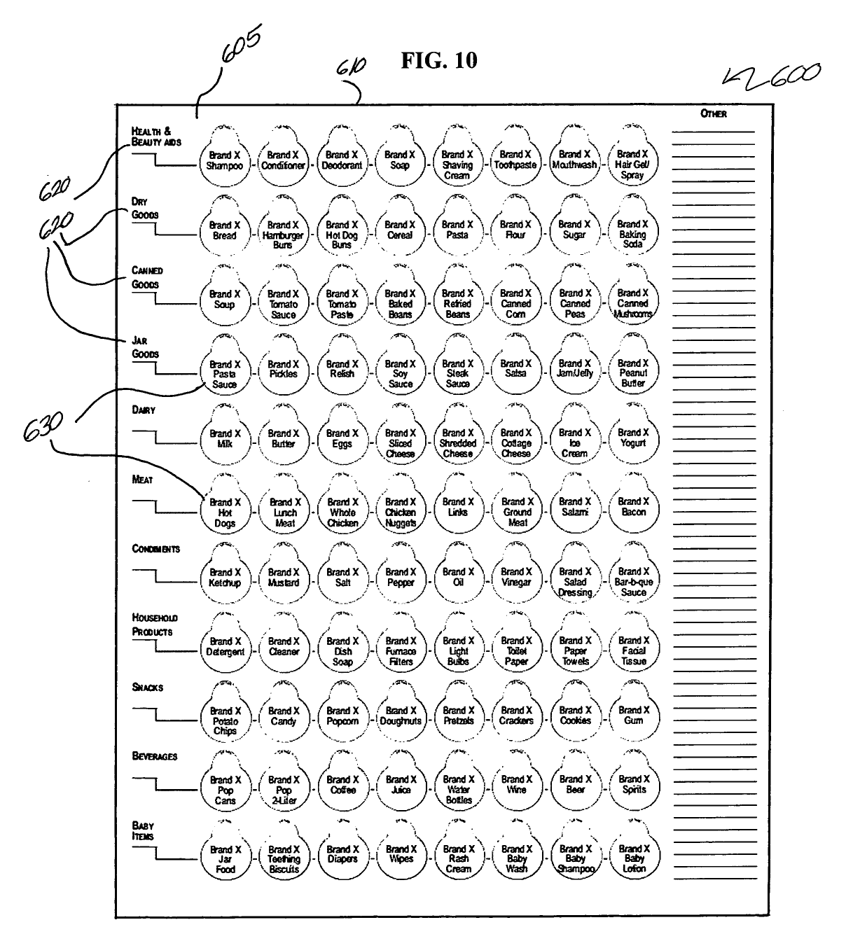

Consumer confusion can be greatly reduced, and more likely completely eliminated, upon choosing a particular product having the label system 100 of the present invention. A consumer removes reminder label 400 from foundation label 110, and adheres the reminder label to a shopping list 600 such as the one shown in FIG. 10. Shopping list 600 can be constructed from any material selected from the group consisting of paper, plastic, metal, wood, polymer or any combination thereof. Shopping list 600 comprises a first surface 605 and a second surface 610, and wherein at least one of said surfaces has imprinted thereon product categories 620, created by a consumer for customized usage during shopping, under which are further imprinted areas 630 upon which the reminder label 400 can be adhered. In this manner, the consumer has a customized shopping list identifying exactly what products were previously purchased so that there is no consumer confusion when faced with numerous similar products.

In one embodiment, the present invention provides a method of reducing consumer confusion when shopping comprises the steps of:

purchasing a product having thereon a label system comprising:

a foundation label having a first outer boundary defining an area of the foundation label, a first side upon which is imprinted information about a product contained within the package, and a second side coated with an adhesive and contacted to a surface of the package;

a non-stick region upon the first side of the foundation label, the non-stick region having a second outer boundary defining an area of the non-stick region, wherein the non-stick region area is smaller than the foundation label area;

a reminder label having a first side upon which is imprinted information about the product contained within the package, a second side coated with an adhesive, and an outer boundary less than or equal to the second outer boundary of the non-stick region, and releasably secured to the non-stick region; and

wherein the information imprinted upon the first side of the reminder label is from about 0% to about 100% identical to the information imprinted upon the foundation label;

removing the reminder label; and

affixing the reminder label to a shopping list, wherein the shopping list is comprised of a first surface and a second surface, and wherein at least one of said surfaces has imprinted thereupon product categories under which are further imprinted areas on which one or more reminder labels can be affixed.

In another embodiment, the present invention provides a method of reducing consumer confusion when shopping for goods comprising the steps of:

packaging a product in a package having thereon a label system comprising:

a foundation label having a first outer boundary defining an area of the foundation label, a first side upon which is imprinted information about a product contained within the package, and a second side coated with an adhesive and contacted to a surface of the package;

a non-stick region upon the first side of the foundation label, the non-stick region having a second outer boundary defining an area of the non-stick region, wherein the non-stick region area is smaller than the foundation label area;

a reminder label having a first side upon which is imprinted information about the product contained within the package, a second side coated with an adhesive, and an outer boundary less than or equal to the second outer boundary of the non-stick region, and releasably secured to the non-stick region; and

wherein the information imprinted upon the first side of the reminder label is from about 0% to about 100% identical to the information imprinted upon the foundation label; and

offering the product for sale to a consumer.

The above described embodiments of the invention are intended to be illustrative only. Numerous alternative embodiments may be devised by those skilled in the art without departing from the spirit and scope of the following claims.

What is claimed is:

1. A label system suitable for use on a package comprising:
a foundation label having a first outer boundary defining an area of the foundation label, a first side upon which is imprinted information about a product contained within the package, and a second side coated with an adhesive and contacted to a surface of the package;
a non-stick region upon the first side of the foundation label, the non-stick region having a second outer boundary defining an area of the non-stick region, wherein the non-stick region area is smaller than the foundation label area;
a reminder label having a first side upon which is imprinted information about the product contained within the package, a second side coated with an adhesive, and an outer boundary less than or equal to the second outer boundary of the non-stick region, and releasably secured to the non-stick region; and
wherein the information imprinted upon the first side of the reminder label is from about 0% to about 100% identical to the information imprinted upon the foundation label.

2. The label system of claim 1 further comprising a shopping list having a first surface and a second surface, and wherein at least on of said surfaces have imprinted thereupon product categories under which are further imprinted areas on which the reminder label can be adhered.

3. The label system of claim 1, wherein the foundation label is integrated into the package.

4. The label system of claim 1, wherein the non-stick region is integrally formed with the foundation label.

5. The label system of claim 1, wherein the non-stick region is comprised of a material having a negligible thickness, a first side, and a second side, wherein the first side of the material is coated with wax or silicon to form a non-stick surface, and the second side is coated with an adhesive and contacted to the first side of the foundation layer.

6. The label system of claim 1, wherein the non-stick region is comprised of a material that is sprayed onto the first surface of the foundation layer.

7. The label system of claim 6, wherein the material is wax.

8. The label system of claim 6, wherein the material is silicon.

9. The label system of claim 1, wherein the reminder label is further comprised of a pull tab.

10. The label system of claim 1, wherein the information imprinted upon the first side of the reminder label is from about 10% to about 90% identical to the information imprinted upon the foundation label.

11. The label system of claim 1, wherein the information imprinted upon the first side of the reminder label is from about 20% to about 80% identical to the information imprinted upon the foundation label.

12. The label system of claim 1, wherein the information imprinted upon the first side of the reminder label is from about 30% to about 70% identical to the information imprinted upon the foundation label.

13. The label system of claim 1, wherein the information imprinted upon the first side of the reminder label is from about 40% to about 60% identical to the information imprinted upon the foundation label.

14. The label system of claim 1, wherein the information imprinted upon the first side of the reminder label is about 50% identical to the information imprinted upon the foundation label.

15. A method of reducing consumer confusion when shopping comprising the steps of:
purchasing a product having thereon a label system comprising:
a foundation label having a first outer boundary defining an area of the foundation label, a first side upon which is imprinted information about a product contained within the package, and a second side coated with an adhesive and contacted to a surface of the package;
a non-stick region upon the first side of the foundation label, the non-stick region having a second outer boundary defining an area of the non-stick region, wherein the non-stick region area is smaller than the foundation label area;
a reminder label having a first side upon which is imprinted information about the product contained within the package, a second side coated with an adhesive, and an outer boundary less than or equal to the second outer boundary of the non-stick region, and releasably secured to the non-stick region; and
wherein the information imprinted upon the first side of the reminder label is from about 0% to about 100% identical to the information imprinted upon the foundation label;
removing the reminder label; and
affixing the reminder label to a shopping list, wherein the shopping list is comprised of a first surface and a second surface, and wherein at least one of said surfaces has imprinted thereupon product categories under which are further imprinted areas on which one or more reminder labels can be affixed.

18. A method of reducing consumer confusion when shopping for goods comprising the steps of:
packaging a product in a package having thereon a label system comprising:
a foundation label having a first outer boundary defining an area of the foundation label, a first side upon which is imprinted information about a product contained within the package, and a second side coated with an adhesive and contacted to a surface of the package;
a non-stick region upon the first side of the foundation label, the non-stick region having a second outer boundary defining an area of the non-stick region, wherein the non-stick region area is smaller than the foundation label area;
a reminder label having a first side upon which is imprinted information about the product contained within the package, a second side coated with an adhesive, and an outer boundary less than or equal to the second outer boundary of the non-stick region, and releasably secured to the non-stick region; and
wherein the information imprinted upon the first side of the reminder label is from about 0% to about 100% identical to the information imprinted upon the foundation label; and
offering the product for sale to a consumer.

19. The method of claim 18, wherein the labeling system further comprises a shopping list comprising a first surface and a second surface, at least one of said surfaces has imprinted thereupon product categories under which are further imprinted areas on which one or more reminder labels can be affixed.

20. The shopping list of claim 19, wherein the shopping list is constructed from a material selected from group consisting of paper, plastic, metal, wood, polymer or any combination thereof.
